(19) United States
(12) Patent Application Publication
(10) Pub. No.: US 2016/0054791 A1
(43) Pub. Date: Feb. 25, 2016

(54) NAVIGATING AUGMENTED REALITY CONTENT WITH A WATCH

(71) Applicant: DAQRI, LLC, Los Angeles, CA (US)

(72) Inventors: Brian Mullins, Sierra Madre, CA (US); Matthew Kammerait, West Hollywood, CA (US); Christopher Broaddus, Mountain View, CA (US)

(21) Appl. No.: 14/467,438

(22) Filed: Aug. 25, 2014

(51) Int. Cl. G06F 3/01; G06T 19/00; G09G 5/12; G06F 3/0488; G06F 3/0482; G02B 27/01; G06F 3/041

(52) U.S. Cl. CPC G06F 3/011; G02B 27/017; G06T 19/006; G06F 3/0416; G06F 3/0488; G06F 3/0482; G09G 5/12; G09G 2354/00

(57) ABSTRACT

A system and method for navigating augmented reality (AR) content with a watch are described. A head mounted device identifies a watch, maps and generates a display of an AR menu in a transparent display of the head mounted device. The AR menu is displayed as a layer on the watch. The head mounted device detects a physical user interaction on the watch. The head mounted device navigates the AR menu in response to detecting the physical user interaction on the watch.

### TECHNICAL FIELD

The subject matter disclosed herein generally relates to the processing of data. Specifically, the present disclosure addresses systems and methods for navigating augmented reality content with a wearable device.

### BACKGROUND

A device can be used to generate and display data in addition to an image captured with the device. For example, augmented reality (AR) is a live, direct or indirect view of a physical, real-world environment whose elements are augmented by computer-generated sensory input such as sound, video, graphics or GPS data. With the help of advanced AR technology (e.g., adding computer vision and object recognition) the information about the surrounding real world of the user becomes interactive. Device-generated (e.g., artificial) information about the environment and its objects can be overlaid on the real world.

### BRIEF DESCRIPTION OF THE DRAWINGS

Some embodiments are illustrated by way of example and not limitation in the figures of the accompanying drawings.

FIG. 1 is a block diagram illustrating an example of a network suitable for navigating augmented reality content using a watch, according to some example embodiments.

FIG. 2 is a block diagram illustrating an example embodiment of modules (e.g., components) of a head mounted device.

FIG. 3 is a block diagram illustrating an example embodiment of modules of a smartwatch recognition module.

FIG. 4 is a block diagram illustrating an example embodiment of modules of a smartwatch navigation module.

FIG. 5 is a block diagram illustrating an example embodiment of modules of an AR content generator module.

FIG. 6 is a block diagram illustrating an example embodiment of modules of an AR content mapping module.

FIG. 7 is a block diagram illustrating an example embodiment of a smartwatch.

FIG. 8 is a block diagram illustrating an example embodiment of a server.

FIG. 9 is a ladder diagram illustrating an example embodiment of an operation of a head mounted device with a smartwatch.

FIG. 10 is a ladder diagram illustrating another example embodiment of an operation of a head mounted device with a smartwatch.

FIG. 11 is a ladder diagram illustrating another example embodiment of an operation of a head mounted device with a smartwatch and a server.

FIG. 12 is a flowchart illustrating an example operation of navigating augmented reality content with a smartwatch.

FIG. 13 is a flowchart illustrating another example operation of navigating augmented reality content with a smartwatch.

FIG. 14A is a diagram illustrating an example operation of navigating augmented reality content with a smartwatch.

FIG. 14B is a diagram illustrating another example operation of navigating augmented reality content with a smartwatch.

FIG. 14C is a diagram illustrating another example operation of navigating augmented reality content with a smartwatch.

FIG. 14D is a diagram illustrating another example operation of navigating augmented reality content with a smartwatch.

FIG. 15 is a block diagram illustrating components of a machine, according to some example embodiments, able to read instructions from a machine-readable medium and perform any one or more of the methodologies discussed herein.

FIG. 16 is a block diagram illustrating a mobile device, according to an example embodiment.

### DETAILED DESCRIPTION

Example methods and systems are directed navigating AR content using a watch or another wearable device. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

AR applications allow a user to experience information, such as in the form of a virtual object such as a three-dimensional (3D) virtual object overlaid on an image or a view of a physical object (e.g., a gauge) captured with a camera of a head mounted device (HMD). The HMD may include a wearable computing device such as eyeglasses or a helmet having optical sensors and a display. The physical object may include a visual reference (e.g., a recognized image, pattern, or object, or unknown objects) that the AR application can identify using predefined objects or machine vision. A visualization of the additional information (also referred to as AR content), such as the 3D virtual object overlaid or engaged with a view or an image of the physical object, is generated in a display of the HMD. The display of the HMD may be transparent. The display may be part of a visor of a helmet. The 3D virtual object may be selected based on the recognized visual reference or captured image of the physical object. A rendering of the visualization of the 3D virtual object may be based on a position of the display relative to the visual reference. Other AR applications allow a user to experience visualization of the additional information overlaid on top of a view or an image of any object in the real physical world. The virtual object may include a 3D virtual object, a two-dimensional (2D) virtual object. For example, the 3D virtual object may include a 3D view of an engine part or an animation. The 2D virtual object may include a 2D view of a dialog box, menu, or written information such as statistics information for properties or physical characteristics of the corresponding physical object (e.g., temperature, mass, velocity, tension, stress). The AR content (e.g., image of the virtual object, virtual menu) may be rendered at the HMD or at a server in communication with the HMD. In one example embodiment, a user of the HMD may navigate the AR content with a watch or any wearable device. In another example embodiment, the user of the HMD may navigate the AR content using gestures on a body part (e.g., wrist, arm, hand, fingers) of the user.

A system and method for navigating AR content using a watch are described. In one example embodiment, an AR application identifies a watch or a wearable device on a body part (e.g., arm, wrist, hand). The AR application maps and generates a display of an AR menu in a transparent display of the HMD. The AR menu is displayed as a layer on the watch or wearable device. The AR application detects a physical user interaction (e.g., the user's finger tapping or swiping a face of the watch, the user's finger pushing a button on the watch) on the watch. The AR application navigates the AR menu in response to detecting the physical user interaction on the watch.

In some example embodiments, the AR application receives an image of the watch or wearable device from a camera of the HMD. The AR application determines feature points of the watch or wearable device and identifies the watch or wearable device based on the feature points.

In some example embodiments, the AR application establishes a wirelessly communication with the watch or wearable device and receives an identification of a touch gesture on the watch or wearable device. A navigation function is mapped to the identification of the touch gesture on the watch or wearable device. The AR application accesses the AR menu corresponding to the watch or wearable device.

In some example embodiments, the camera of the HMD captures an image of the physical object. The physical object is identified. The AR application retrieves the AR menu corresponding to the identified physical object.

In some example embodiments, the AR application determines a geographic location of the HMD and identifies the physical object received from the camera of the HMD at the geographic location. The AR application retrieves the AR menu corresponding to the identified object and based on the geographic location of the HMD.

In some example embodiments, the AR application maps a size and orientation of the AR menu in the transparent display based on an image of the watch or wearable device. The AR menu may include a carousel menu displayed adjacent or on top of the watch or wearable device. The AR application updates the display of the AR menu in response to the physical user interaction on the watch. The physical user interaction comprises pressing a button on the watch or wearable device or touching or swiping a touch-sensitive surface of the watch.

In some example embodiments, the AR application receives an identification of the physical user interaction on the watch and retrieves a corresponding navigation command corresponding to the identification of the physical user interaction. The AR application performs the corresponding navigation command.

In some example embodiments, the AR application determines a position of the watch or wearable device relative to the HMD based on an inertial motion sensor in the watch. The AR application generates or activates the display of the AR menu in the transparent display in response to a first position of the watch (e.g., raised arm) and terminates the display of the AR menu in the transparent display in response to a second position of the watch (e.g., lowered arm).

In another example embodiment, a non-transitory machine-readable storage device may store a set of instructions that, when executed by at least one processor, causes the at least one processor to perform the method operations discussed within the present disclosure.

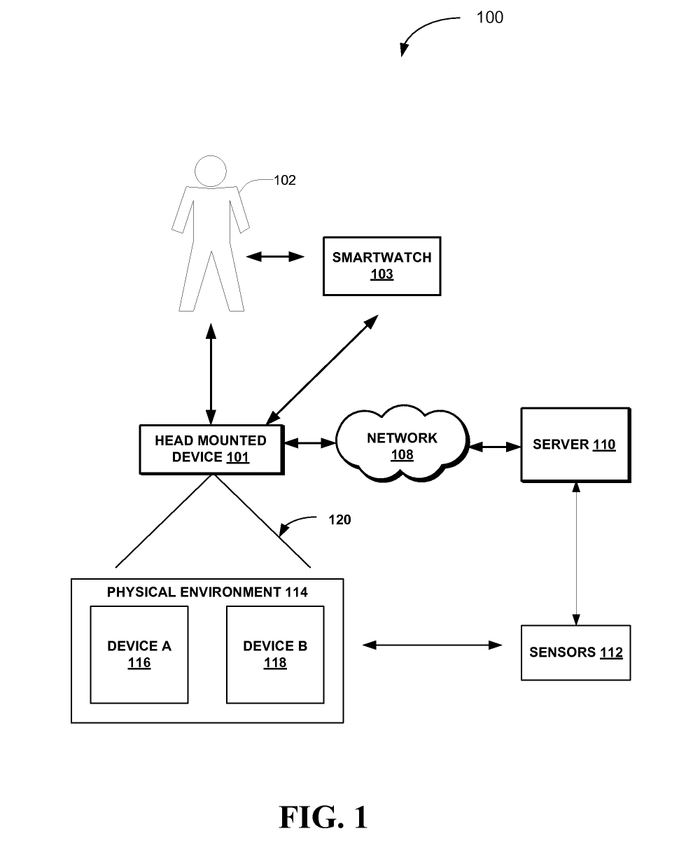

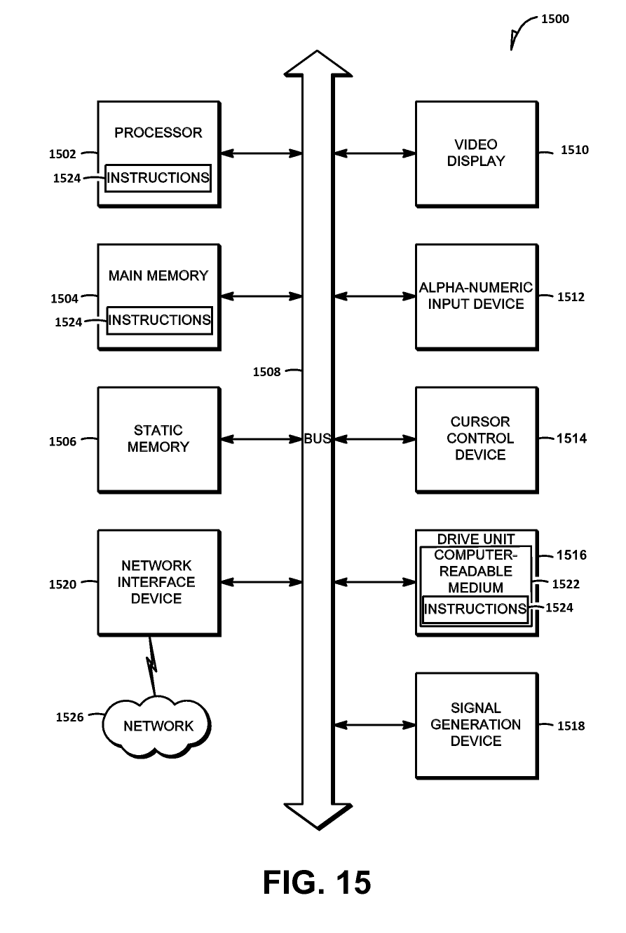

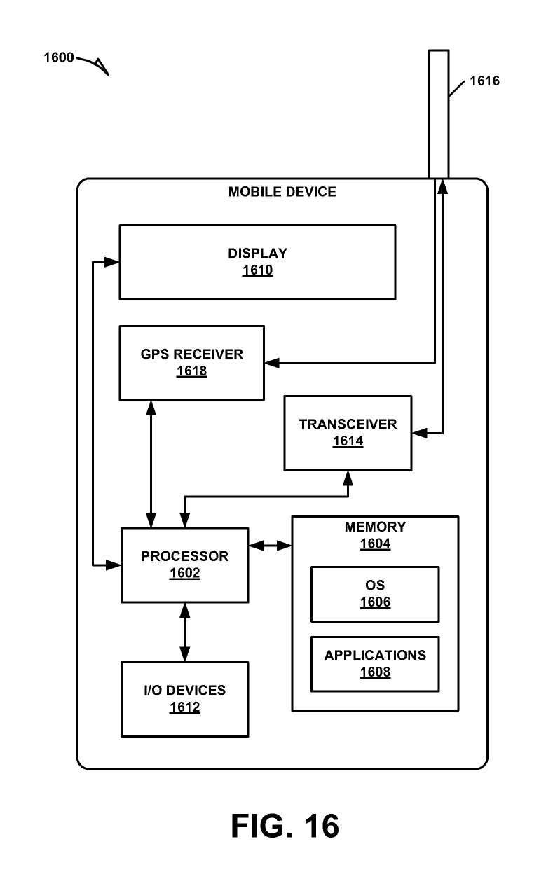

FIG. 1 is a network diagram illustrating a network environment 100 suitable for operating an augmented reality application of a HMD, according to some example embodiments. The network environment 100 includes a head mounted device (HMD) 101 and a server 110, communicatively coupled to each other via a network 108. The HMD 101 and the server 110 may each be implemented in a computer system, in whole or in part, as described below with respect to FIGS. 15 and 16.

The server 110 may be part of a network-based system. For example, the network-based system may be or include a cloud-based server system that provides additional information, such as 3D models or other virtual objects, to the HMD 101.

A user 102 may wear the HMD 101 to capture an image of several devices (e.g., device A 116, device B 118) in a real world physical environment 114 viewed by the user 102. The user 102 may be a human user (e.g., a human being), a machine user (e.g., a computer configured by a software program to interact with the HMD 101), or any suitable combination thereof (e.g., a human assisted by a machine or a machine supervised by a human). The user 102 is not part of the network environment 100, but is associated with the HMD 101 and may be a user 102 of the HMD 101. For example, the HMD 101 may be a computing device with a camera and a display such as a wearable computing device (e.g., smart glasses, smart helmet, smart visor, smart faceshield, smart contact lenses). The computing device may be removably mounted to the head of the user 102. In one example, the display may be a screen that displays what is captured with a camera of the HMD 101. In another example, the display of the HMD 101 may be transparent or semi-transparent such as in lenses of wearable computing glasses, the visor or face shield of a helmet.

The user 102 may wear a smartwatch 103, a watch, or another wearable device on a wrist of the user 102. The smartwatch 103 communicated wirelessly with the HMD 101 to enable the user to view and manipulate a virtual menu on the smartwatch 103. Components of the smartwatch 103 are described in more detail with respect to FIG. 7.

The user 102 may be a user of an AR application in the HMD 101 and at the server 110. The AR application may provide the user 102 with an AR experience triggered by identified objects in the physical environment 114. The physical environment 114 may include identifiable objects such as a 2D physical object (e.g., a picture), a 3D physical object (e.g., a factory machine), a location (e.g., at the bottom floor of a factory), or any references (e.g., perceived corners of walls or furniture) in the real world physical environment 114. The AR application may include computer vision recognition to determine corners, objects, lines, and letters. The user 102 may point a camera of the HMD 101 to capture an image of the devices 116 and 118 in the physical environment 114.

In one embodiment, the objects in the image are tracked and recognized locally in the HMD 101 using a local context recognition dataset or any other previously stored dataset of the AR application of the HMD 101. The local context recognition dataset module may include a library of virtual objects associated with real-world physical objects or references. In one example, the HMD 101 identifies feature points in an image of the devices 116, 118 to determine different planes (e.g., edges, corners, surface, dial, letters). The HMD 101 may also identify tracking data related to the devices 116, 118 (e.g., GPS location of the HMD 101, orientation, distances to devices 116, 118). If the captured image is not recognized locally at the HMD 101, the HMD 101 can download additional information (e.g., 3D model or other augmented data) corresponding to the captured image, from a database of the server 110 over the network 108.

In another embodiment, the devices 116, 118 in the image are tracked and recognized remotely at the server 110 using a remote context recognition dataset or any other previously stored dataset of an AR application in the server 110. The remote context recognition dataset module may include a library of virtual objects or augmented information associated with real-world physical objects or references.

Sensors 112 may be associated with, coupled to, related to the devices 116 and 118 in the physical environment 114 to measure a location, information, reading of the devices 116 and 118. Examples of measured reading may include and but are not limited to weight, pressure, temperature, velocity, direction, position, intrinsic and extrinsic properties, acceleration, and dimensions. For example, sensors 112 may be disposed throughout a factory floor to measure movement, pressure, orientation, and temperature. The server 110 can compute readings from data generated by the sensors 112. The server 110 can generate virtual indicators such as vectors or colors based on data from sensors 112. Virtual indicators are then overlaid on top of a live image of the devices 116 and 118 to show data related to the devices 116 and 118. For example, the virtual indicators may include arrows with shapes and colors that change based on real-time data. The visualization may be provided to the HMD 101 so that the HMD 101 can render the virtual indicators in a display of the HMD 101. In another embodiment, the virtual indicators are rendered at the server 110 and streamed to the HMD 101. The HMD 101 displays the virtual indicators or visualization corresponding to a display of the physical environment 114 (e.g., data is displayed adjacent to the devices 116 and 118).

The sensors 112 may include other sensors used to track the location, movement, and orientation of the HMD 101 externally without having to rely on the sensors internal to the HMD 101. The sensors 112 may include optical sensors (e.g., depth-enabled 3D camera), wireless sensors (Bluetooth, Wi-Fi), GPS sensor, and audio sensor to determine the location of the user 102 having the HMD 101, distance of the user 102 to the tracking sensors 112 in the physical environment 114 (e.g., sensors placed in corners of a venue or a room), the orientation of the HMD 101 to track what the user 102 is looking at (e.g., direction at which the HMD 101 is pointed, HMD 101 pointed towards a player on a tennis court, HMD 101 pointed at a person in a room).

In another embodiment, data from the sensors 112 and internal sensors in the HMD 101 may be used for analytics data processing at the server 110 (or another server) for analysis on usage and how the user 102 is interacting with the physical environment 114. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 moved with the HMD 101 when looking at the physical or virtual object, which features of the virtual object the user 102 interacted with (e.g., such as whether a user 102 tapped on a link in the virtual object), and any suitable combination thereof. The HMD 101 receives a visualization content dataset related to the analytics data. The HMD 101 then generates a virtual object with additional or visualization features, or a new experience, based on the visualization content dataset.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIGS. 15 and 16. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., device 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

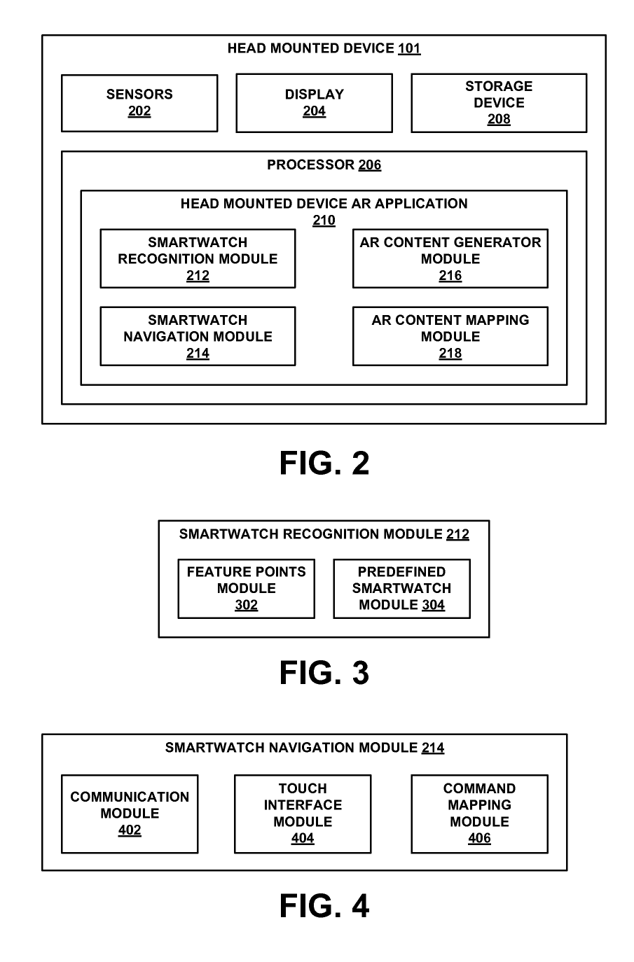

FIG. 2 is a block diagram illustrating modules (e.g., components) of the HMD 101, according to some example embodiments. The HMD 101 may include sensors 202, a display 204, a processor 206, and a storage device 208. For example, the HMD 101 may be a wearing computing device (e.g., glasses or helmet), a tablet computer, a navigational device, or a smart phone of a user. The user may be a human user (e.g., a human being), a machine user (e.g., a computer configured by a software program to interact with the HMD 101), or any suitable combination thereof (e.g., a human assisted by a machine or a machine supervised by a human).

The sensors 202 may include, for example, a proximity or location sensor (e.g., Near Field Communication, GPS, Bluetooth, Wi-Fi), an optical sensor(s) (e.g., camera), an orientation sensor(s) (e.g., gyroscope, or an inertial motion sensor), an audio sensor (e.g., a microphone), or any suitable combination thereof. For example, the sensors 202 may include rear facing camera(s) and front facing camera(s) disposed in the HMD 101. It is noted that the sensors 202 described herein are for illustration purposes. Sensors 202 are thus not limited to the ones described. The sensors 202 may be used to generate internal tracking data of the HMD 101 to determine what the HMD 101 is capturing or looking at in the real physical world. Furthermore, a virtual menu may be activated when the sensors 202 indicate that the HMD 101 is oriented downward (e.g., when the user tilts his head to watch his wrist).

The display 204 may include a transparent visor or face shield of the helmet. The display 204 may also include a touchscreen display configured to receive a user input via a contact on the touchscreen display. In one example, the display 204 may include a screen configured to display images generated by the processor 206. In another example, the display 204 may be transparent or semi-opaque so that the user 102 can see through the display 204 (e.g., Head-Up Display).

The processor 206 may include a HMD AR application 210 for generating a display of information related to the device 116 when the HMD 101 captures an image of the device 116 or is within proximity of the device 116. The HMD AR application 210 may generate a display of a holographic or virtual menu overlaid on a view of the smartwatch 103. In one example embodiment, the HMD AR application 210 may include a smartwatch recognition module 212, a smartwatch navigation module 214, an AR content generator module 216, and an AR content mapping module 218.

The smartwatch recognition module 212 identifies the smartwatch 103 that the HMD 101 is pointed at the smartwatch 103. The smartwatch recognition module 212 may detect, generate, and identify identifiers such as feature points of the smartwatch 103 being viewed or pointed at the HMD 101 using an optical device of the HMD 101 to capture the image of the smartwatch 103. In another embodiment, the smartwatch recognition module 212 may be configured to identify a watch, a wearable device on a wrist of the user, any other wearable devices on a body part of the user, a body part of the user (e.g., wrist). In one example embodiment, the smartwatch recognition module 212 may include a feature points module 302 and a predefined smartwatch module 304 as illustrated in FIG. 3.

The identification of the smartwatch 103 may be performed in different ways. For example, the feature points module 302 may determine feature points of the smartwatch 103 based on several image frames of the smartwatch 103. The feature points module 302 also determines the identity of the smartwatch 103 using computer vision algorithm. In another example, a unique identifier may be associated with the smartwatch 103. The unique identifier may be a unique wireless signal or a unique visual pattern such that the smartwatch recognition module 212 can look up the identity of the smartwatch based on the unique identifier from a local or remote content database. In another example embodiment, the smartwatch recognition module 212 includes a watch recognition algorithm in a predefined smartwatch module 304 to determine an identity of the watch or a wearable device. The predefined smartwatch module 304 may be configured to determine whether the captured image matches an image locally stored in a local database of images and corresponding additional information (e.g., three-dimensional model and interactive features) on the viewing device 101.

Referring back to FIG. 2, the smartwatch navigation module 214 detects a physical user interaction on the watch 103 and enables navigation of an AR menu in response to the physical user interaction on the watch. In one embodiment, the smartwatch navigation module 214 determines a position of the smartwatch 103 relative to the HMD 101 based on an inertial motion sensor in the smartwatch 103. For example, the AR menu is displayed when the user raises his arm to look at his wrist. The AR menu disappears when the user lowers his arm. In one example embodiment, the smartwatch navigation module 214 includes a communication module 402, a touch interface module 404, and a command mapping module 406 as illustrated in FIG. 4.

The communication module 402 establishes a wirelessly communication with the smartwatch 103 using wi-fi, Bluetooth, or other wireless data communication means. The touch interface module 404 receives an identification of a touch gesture on the smartwatch 103. The command mapping module 406 maps a navigation function of the AR menu or content to the identification of the touch gesture on the smartwatch 103. For example, a swipe up gesture on the screen of the smartwatch 103 may correspond to scrolling a menu upward. A tap on the screen of the smartwatch 130 may correspond to a selection function in the AR menu.

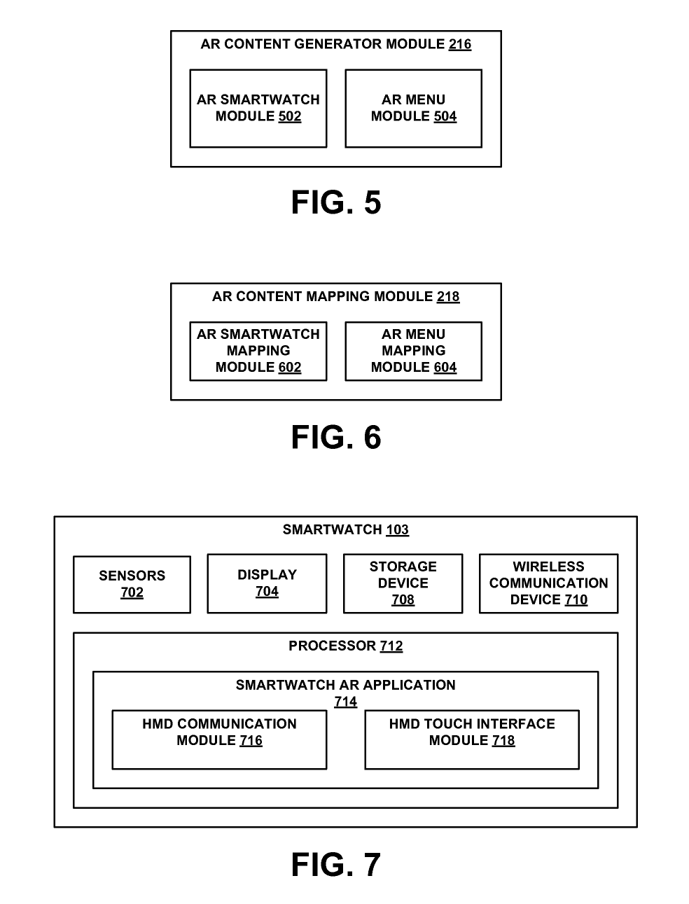

Referring back to FIG. 2, the AR content generator module 216 generates a display of an AR menu in the display 204. The AR menu may be displayed as a visual layer on the smartwatch 103. In one example embodiment, the AR content generator module 216 includes an AR smartwatch module 502 and an AR menu module 504 as illustrated in FIG. 5.

The AR smartwatch module 502 retrieves a 3D model of a smartwatch corresponding to the identified smartwatch 103, a wrist of the user, or a wearable device on a wrist of the user. The AR menu module 504 retrieves a virtual menu corresponding to the device 116. In another embodiment, the AR content generator module 216 identifies an object received from a camera of the HMD 101 to retrieve the AR menu corresponding to the identified object (e.g., device 116). In another embodiment, the AR content generator module 216 determines a geographic location of the HMD 101 to identify the object received from the camera at the geographic location of the HMD 101, and retrieves the AR menu corresponding to the identified object and based on the geographic location of the HMD 101.

Referring back to FIG. 2, the AR content mapping module 218 determines the position and size of the rendered object (e.g., AR menu and other virtual objects) to be displayed in relation to an image or a view of the smartwatch 103. For example, the AR content mapping module 218 may map and display animation or other graphics as a layer on top of the smartwatch 103 or a wrist of the user. The AR content mapping module 218 may track the image of the smartwatch 103 and render the virtual object based on the position of the image of the smartwatch in a display of the HMD 101. In one example embodiment, the AR content mapping module 218 includes an AR smartwatch mapping module 602 and an AR menu mapping module 604 as illustrated in FIG. 6.

The AR smartwatch mapping module 602 maps a first location in the transparent display to display a 3D model of a smartwatch as a visual layer on the smartwatch 103. The AR menu mapping module 604 maps a second location in the transparent display to display the virtual menu corresponding to the device 116.

The AR content mapping module 218 may also include a local rendering engine that generates a visualization of a 3D virtual object overlaid (e.g., superimposed upon, or otherwise displayed in tandem with) on a view of the device 116. A visualization of the 3D virtual object may be manipulated by adjusting a position of the physical object (e.g., its physical location, orientation, or both) relative to the camera of the HMD 101. Similarly, the visualization of the 3D virtual object may be manipulated by adjusting a position of the camera of the HMD 101 relative to the device 116.

In one example embodiment, the HMD 101 accesses from the storage device 208 a visualization model (e.g., virtual menu) corresponding to the image of the object (e.g., device 116). In another example, the HMD 101 receives a visualization model corresponding to the object from the server 110. The HMD 101 then renders the visualization model to be displayed in relation to an image of the device being viewed by the HMD 101 or in relation to a position and orientation of the HMD 101 relative to the device 116. The HMD AR application 210 may adjust a position of the rendered visualization model in the display 204 to correspond with the last tracked position of the object (as last detected either from the sensors 202 of the HMD 101 or from the tracking sensors 112 of the server 110).

Referring back to FIG. 2, the storage device 208 may be configured to store a database of identifiers of wearable devices (e.g., watches and smartwatches). In another embodiment, the database may also include visual references (e.g., images) and corresponding experiences (e.g., 3D virtual objects, interactive features of the 3D virtual objects). In one embodiment, the storage device 208 includes a primary content dataset, a contextual content dataset, and a visualization content dataset. The primary content dataset includes, for example, a first set of images and corresponding experiences (e.g., interaction with 3D virtual object models). For example, an image may be associated with one or more virtual object models. The primary content dataset may include a core set of images or the most popular images determined by the server 110. The core set of images may include a limited number of images identified by the server 110. For example, the core set of images may include the images depicting covers of the ten most viewed devices and their corresponding experiences (e.g., virtual objects that represent the ten most sensing devices in a factory floor). In another example, the server 110 may generate the first set of images based on the most popular or often scanned images received at the server 110. Thus, the primary content dataset does not depend on objects or images scanned by the smartwatch recognition module 212 of the HMD 101.

The contextual content dataset includes, for example, a second set of images and corresponding experiences (e.g., three-dimensional virtual object models) retrieved from the server 110. For example, images captured with the HMD 101 that are not recognized (e.g., by the server 110) in the primary content dataset are submitted to the server 110 for recognition. If the captured image is recognized by the server 110, a corresponding experience may be downloaded at the HMD 101 and stored in the contextual content dataset. Thus, the contextual content dataset relies on the context in which the HMD 101 has been used. As such, the contextual content dataset depends on objects or images scanned by the recognition module 214 of the HMD 101.

In one embodiment, the HMD 101 may communicate over the network 108 with the server 110 to retrieve a portion of a database of visual references, corresponding 3D virtual objects, and corresponding interactive features of the 3D virtual objects.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

FIG. 7 is a block diagram illustrating modules (e.g., components) of the smartwatch 103, according to some example embodiments. The smartwatch 103 may include sensors 702, a display 704, a storage device 708, a wireless communication device 710, and a processor 712.

The sensors 702 may include, for example, a proximity or location sensor (e.g., Near Field Communication, GPS, Bluetooth, Wi-Fi), an optical sensor(s) (e.g., camera), an orientation sensor(s) (e.g., gyroscope, or an inertial motion sensor), an audio sensor (e.g., a microphone), or any suitable combination thereof.

The display 704 may also include a touchscreen display configured to receive a user input via a contact on the touchscreen display. In one example, the display 704 may include a screen configured to display images generated by the processor 712. The storage device 708 stores information about the HMD 101 for authentication. The wireless communication device 710 includes a communication device (e.g., Bluetooth device, Wi-Fi device) that enables the smartwatch 103 to wirelessly communicate with the HMD 101.

The processor 712 may include a smartwatch AR application 714 for interfacing with the HMD 101. In one example embodiment, the smartwatch AR application 714 includes a HMD communication module 716 and a HMD touch interface module 718. The HMD communication module 716 enables communication between the smartwatch 103 and the HMD 101. The HMD touch interface module 718 identifies operations on the smartwatch to the HMD 101. For example, the HMD touch interface module 718 may detect that the user has pushed on a particular button of the watch. The HMD touch interface module 718 communicates that information to the HMD 101 that maps an AR menu function to the particular button.

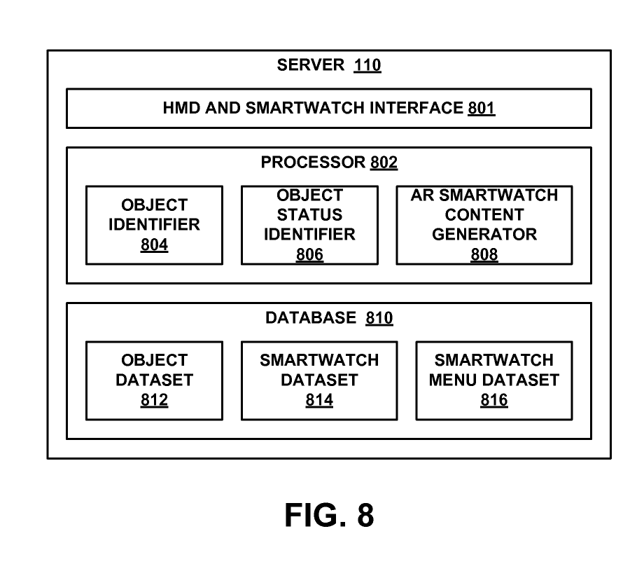

FIG. 8 is a block diagram illustrating modules (e.g., components) of the server 110. The server 110 includes a HMD and smartwatch interface 801, a processor 802, and a database 810. The HMD and smartwatch interface 801 may communicate with the HMD 101, the smartwatch 103, and sensors 112 (FIG. 1) to receive real time data.

The processor 802 may include an object identifier 804, an object status identifier 806, and an AR smartwatch content generator 808. The object identifier 804 may identify devices 116, 118 based on a picture or image frame received from the HMD 101. In another example, the HMD 101 already has identified devices 116, 118 and has provided the identification information to the object identifier 804.

The object status identifier 806 determines the physical characteristics associated with the devices identified. For example, if the device is a gauge, the physical characteristics may include functions associated with the gauge, location of the gauge, reading of the gauge, other devices connected to the gauge, safety thresholds or parameters for the gauge.

The AR smartwatch content generator 808 generates an AR content such as a virtual menu associated with the identified device 116 and geographic location of the HMD 101.

The database 810 may store an object dataset 812, a smartwatch dataset 814, and a smartwatch menu dataset 816. The object dataset 812 may include a database of information on devices such as devices 116, 118. In another embodiment, the object dataset 812 includes a primary content dataset and a contextual content dataset. The primary content dataset comprises a first set of images and corresponding virtual object models. The contextual content dataset may include a second set of images and corresponding virtual object models. The smartwatch dataset 814 may include a database of smartwatches or objects triggering the AR menu (e.g., wearable device or identifier on a wrist of a user). The smartwatch menu dataset 816 may include a database of AR menu associated with devices 116 and 118 in the physical environment 114.

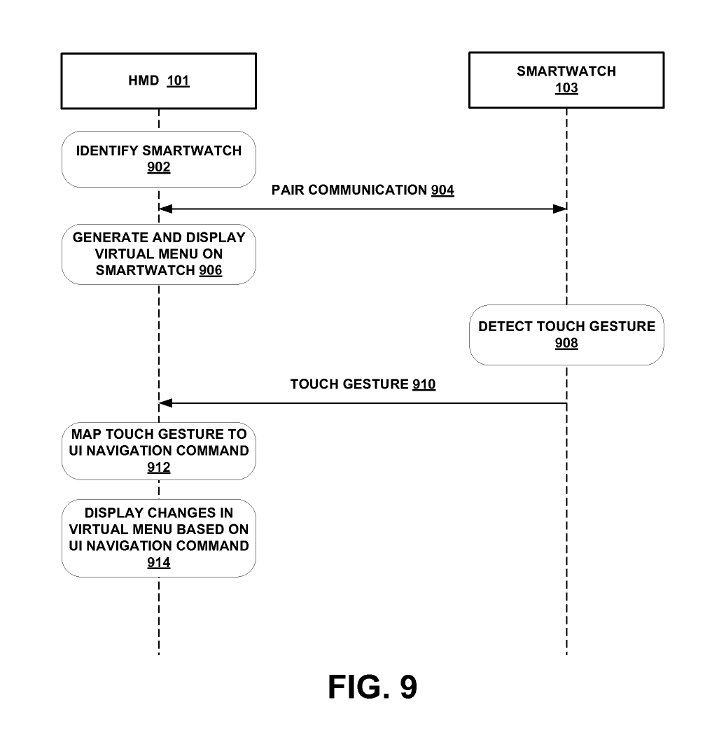

FIG. 9 is a ladder diagram illustrating an example embodiment of an operation of the HMD 101 with the smartwatch 103. At operation 902, the HMD 101 identifies the smartwatch 103. At operation 904, the HMD 101 is paired (e.g., Bluetooth pairing) with the smartwatch 103. At operation 906, the HMD 101 generates and displays a virtual menu overlaid on an arm of the user next to the smartwatch 103. At operation 908, the smartwatch 103 detects a touch gesture on a touch surface of the smartwatch 103. At operation 910, the smartwatch 103 communicates the touch gesture to the HMD 101. At operation 912, the HMD 101 maps the touch gesture to a user interface navigation command for the HMD 101. At operation 914, the HMD 101 displays changes in the virtual menu based on the user interface navigation command.

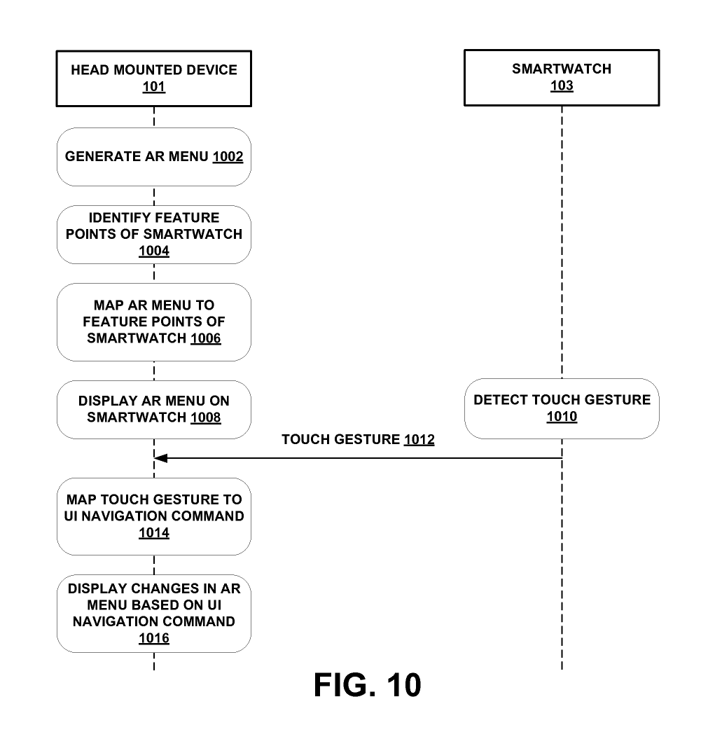

FIG. 10 is a ladder diagram illustrating another example embodiment of an operation of the HMD 101 with the smartwatch 103. At operation 1002, the HMD 101 generates an AR menu. At operation 1004, the HMD 101 identifies feature points of the smartwatch 103. At operation 1006, the HMD 101 maps the AR menu to feature points of the smartwatch 1006 and displays the AR menu as a virtual layer on the smartwatch at operation 1008. At operation 1010, the smartwatch 103 detects a touch gesture or a physical action on the smartwatch 103. At operation 1012, the smartwatch 103 communicates the touch gesture (e.g., an identifier corresponding to the detected touch gesture) to the HMD 101. At operation 1014, the HMD 101 maps the touch gesture to a user interface navigation command. At operation 1016, the HMD 101 displays changes in the AR menu based on the user interface navigation command.

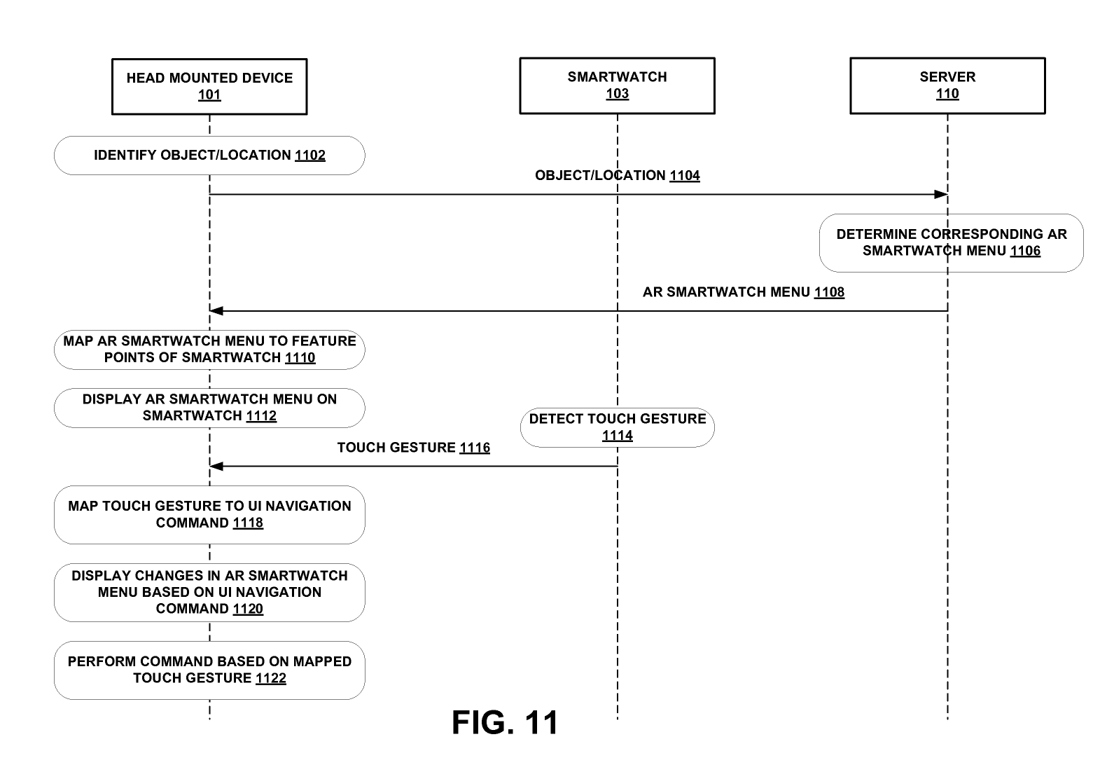

FIG. 11 is a ladder diagram illustrating another example embodiment of an operation of the HMD 101 with the smartwatch 103 and the server 110. At operation 1102, the HMD 101 identifies an object and a location of a physical object (e.g., device 116). At operation 1104, the HMD 101 communicates an identity of the object and the location of the object or HMD 101 to the server 110. At operation 1106, the server 110 retrieves an AR menu corresponding to the object. At operation 1108, the server 110 communicates the AR menu to the HMD 101. At operation 1110, the HMD maps the AR menu to feature points of the smartwatch 103. At operation 1112, the HMD 101 displays the AR menu on the smartwatch 103. At operation 1114, the smartwatch 103 detects a touch gesture. At operation 1116, the smartwatch 103 communicates the touch gesture to the HMD 101. At operation 1118, the HMD 101 maps the touch gesture to a user interface navigation command. At operation 1120, the HMD 101 displays changes in the AR menu based on the user interface navigation command. At operation 1122, the HMD 101 performs a command based on the mapped touch gesture.

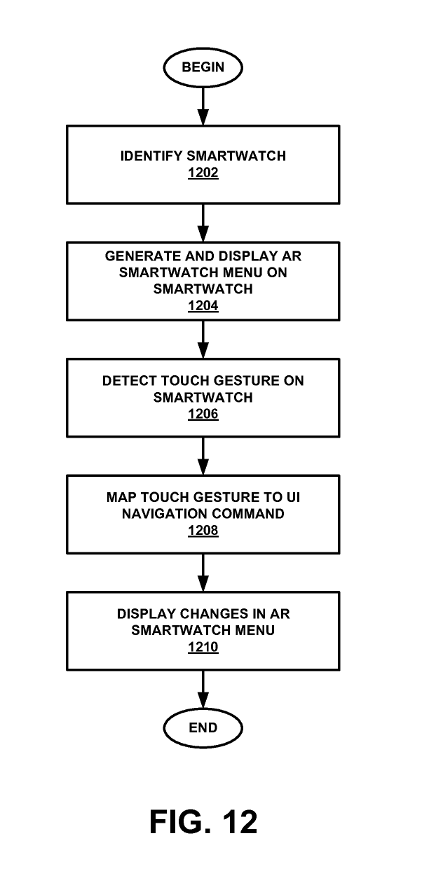

FIG. 12 is a flowchart illustrating an example operation of navigating AR content with the smartwatch 103. At operation 1202, a watch, a smartwatch, a wearable device, or a wrist of a user is identified. In one embodiment, operation 1202 may be implemented using the smartwatch recognition module 212 of FIG. 2.

At operation 1204, a virtual menu is generated and displayed as a visual layer on or next to the smartwatch. In one example, the virtual menu may include a carousel displayed adjacent to the smartwatch. The carousel may rotate about an axis substantially similar to the arm of the user. As such, the smartwatch recognition module 212 may be configured to identify an orientation and position of an arm of the user. In one embodiment, operation 1204 may be implemented using the AR content generator module 216 of FIG. 2.

At operation 1206, a gesture is detected on the face of a smartwatch. For example, the gesture may include a swipe or a tap. The smartwatch may include a touch sensitive surface capable of detecting the gesture. In another embodiment, the gesture may be visually identified based on the movement of the user's finger on the face of the watch captured in the video frames. In one embodiment, operation 1206 may be implemented using the smartwatch navigation module 214 of FIG. 2.

At operation 1208, the identified touch gesture is mapped to a navigation command related to the virtual menu. For example, a swipe up may result in the carousel rotating in one direction. A tap may result in selecting a function, menu, or dialog box in the virtual menu. In one embodiment, operation 1208 may be implemented using the AR content mapping module 218 of FIG. 2.

At operation 1210, changes in the AR menu are displayed in response the mapped navigation command. As such, the virtual carousel is displayed rotating in the direction corresponding to the identified touch gesture. In one embodiment, operation 1210 may be implemented using the AR content mapping module 218 of FIG. 2.

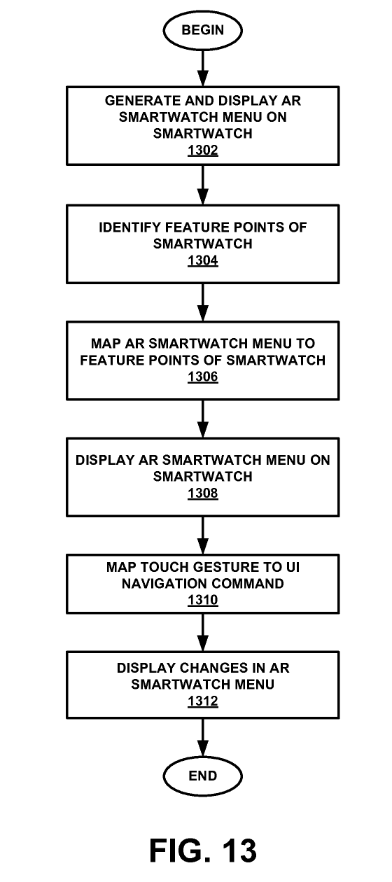

FIG. 13 is a flowchart illustrating another example operation of navigating augmented reality content with a smartwatch. At operation 1302, a virtual menu is generated as an AR menu on a smartwatch. In one embodiment, operation 1302 may be implemented using the AR content generator module 216. At operation 1304, feature points on the smartwatch are identified. For example, the size and shape of the smartwatch are determined using the smartwatch recognition module 212 using computer vision algorithm to detect shapes. At operation 1306, the AR menu is mapped to feature points on the smartwatch. For example, an edge of the AR menu may be positioned next to an edge of the watch. At operation 1308, the AR menu is displayed next to or on the watch. The AR menu may be displayed though the transparent display 204 in such as a way that the eyes of the user perceive the AR menu overlaid next to or on the watch. At operation 1310, touch gestures are mapped to the user interface navigation command using, for example, the command mapping module 406 of FIG. 4. At operation 1312, changes in the AR menu are displayed in response the mapped navigation command. In one embodiment, operation 1312 may be implemented using the AR content mapping module 218 of FIG. 2.

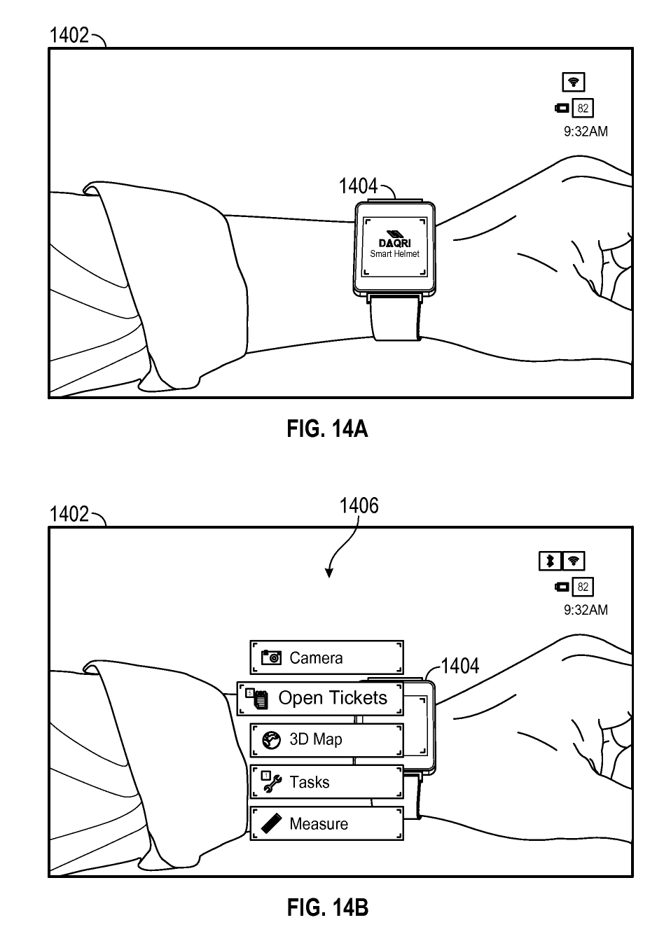

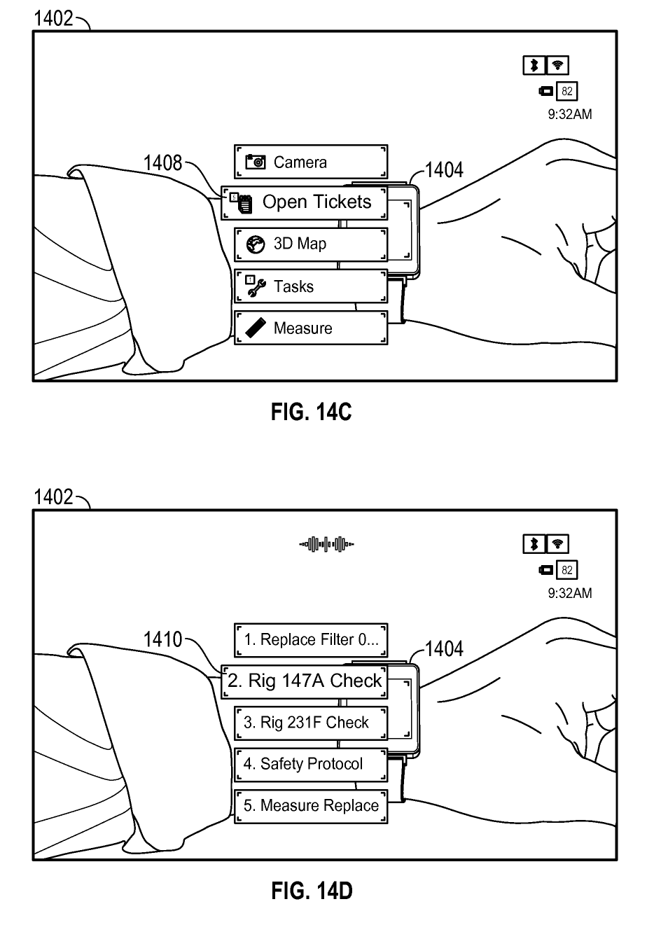

FIG. 14A is a diagram illustrating an example operation of navigating AR content with a smartwatch. The user views, through a transparent display 1402, a watch 1404 on the user's wrist.

FIG. 14B is a diagram illustrating another example operation of navigating augmented reality content with a smartwatch. A virtual menu 1406 is displayed in the transparent display 1402 as a carousel next to the watch 1404.

FIG. 14C is a diagram illustrating another example operation of navigating augmented reality content with a smartwatch. The user may select a command 1408 may using gestures (e.g., a swipe) on the watch 1404, on the wrist on the user, or on any wearable device. The user may also select the command 1408 using predefined gestures as captured by the camera of the HMD 101.

FIG. 14D is a diagram illustrating another example operation of navigating augmented reality content with a smartwatch. The user may select a particular item 1410 in the virtual menu 1406 by tapping on a face of the watch 1404, or activating a physical button on the watch.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 14 is a block diagram of a machine in the example form of a computer system 1400 within which instructions 1424 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1400 includes a processor 1402 (e.g., a central processing unit (CPU), a graphics processing unit (GPU) or both), a main memory 1404 and a static memory 1406, which communicate with each other via a bus 1408. The computer system 1400 may further include a video display unit 1410 (e.g., a liquid crystal display (LCD) or a cathode ray tube (CRT)). The computer system 1400 also includes an alphanumeric input device 1412 (e.g., a keyboard), a user interface (UI) navigation (or cursor control) device 1414 (e.g., a mouse), a disk drive unit 1416, a signal generation device 1418 (e.g., a speaker) and a network interface device 1420.

### Machine-Readable Medium

The disk drive unit 1416 includes a machine-readable medium 1422 on which is stored one or more sets of data structures and instructions 1424 (e.g., software) embodying or utilized by any one or more of the methodologies or functions described herein. The instructions 1424 may also reside, completely or at least partially, within the main memory 1404 and/or within the processor 1402 during execution thereof by the computer system 1400, the main memory 1404 and the processor 1402 also constituting machine-readable media. The instructions 1424 may also reside, completely or at least partially, within the static memory 1406.

While the machine-readable medium 1422 is shown in an example embodiment to be a single medium, the term “machine-readable medium” may include a single medium or multiple media (e.g., a centralized or distributed database, and/or associated caches and servers) that store the one or more instructions 1424 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1424 may further be transmitted or received over a communications network 1426 using a transmission medium. The instructions 1424 may be transmitted using the network interface device 1420 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

### Example Mobile Device

FIG. 15 is a block diagram illustrating a mobile device 1500, according to an example embodiment. The mobile device 1500 may include a processor 1502. The processor 1502 may be any of a variety of different types of commercially available processors 1502 suitable for mobile devices 1500 (for example, an XScale architecture microprocessor, a microprocessor without interlocked pipeline stages (MIPS) architecture processor, or another type of processor 1502). A memory 1504, such as a random access memory (RAM), a flash memory, or other type of memory, is typically accessible to the processor 1502. The memory 1504 may be adapted to store an operating system (OS) 1506, as well as application programs 1508, such as a mobile location enabled application that may provide LBSs to a user. The processor 1502 may be coupled, either directly or via appropriate intermediary hardware, to a display 1510 and to one or more input/output (I/O) devices 1512, such as a keypad, a touch panel sensor, a microphone, and the like. Similarly, in some embodiments, the processor 1502 may be coupled to a transceiver 1514 that interfaces with an antenna 1516. The transceiver 1514 may be configured to both transmit and receive cellular network signals, wireless data signals, or other types of signals via the antenna 1516, depending on the nature of the mobile device 1500. Further, in some configurations, a GPS receiver 1518 may also make use of the antenna 1516 to receive GPS signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A head mounted device comprising:
at least one camera;
a transparent display; and
a hardware processor comprising an augmented reality (AR) application, the AR application configured to have:
a watch recognition module to identify a watch;
an AR content mapping module to map and generate a display of an AR menu in the transparent display, the AR menu displayed as a layer on the watch; and
a navigation module to navigate the AR menu in response to detecting a physical user interaction on the watch.

2. The head mounted device of claim 1, wherein the watch recognition module receives an image of the watch from the at least one camera, determines feature points of the watch, and identifies the watch based on the feature points.

3. The head mounted device of claim 1, wherein the navigation module further comprises:
a communication module to establish a wireless communication with the watch;
a touch interface module to receive an identification of a touch gesture on the watch; and
a command mapping module to map a navigation function to the identification of the touch gesture on the watch.

4. The head mounted device of claim 1, further comprising:
an AR content generator to access the AR menu corresponding to the watch.

5. The head mounted device of claim 1, further comprising:
an AR content generator to identify an object received from the at least one camera of the head mounted device, to retrieve the AR menu corresponding to the identified object.

6. The head mounted device of claim 5, further comprising:
an AR content generator to determine a geographic location of the head mounted device, to identify the object received from the at least one camera at the geographic location of the head mounted device, and to retrieve the AR menu corresponding to the identified object and based on the geographic location of the head mounted device.

7. The head mounted device of claim 1, wherein the AR content mapping module further comprises:
an AR menu mapping module to map a size and orientation of the AR menu in the transparent display based on an image of the watch, the AR menu comprising a carousel menu displayed adjacent to the watch.

8. The head mounted device of claim 1, wherein the navigation module causes an update to the display of the AR menu in response to the physical user interaction on the watch.

9. The head mounted device of claim 1, wherein the navigation module is to receive an identification of the physical user interaction on the watch, retrieve a corresponding navigation command corresponding to the identification of the physical user interaction, and cause the AR application to perform the corresponding navigation command,
wherein the physical user interaction comprises pressing a button on the watch or touching a touch-sensitive surface of the watch.

10. The head mounted device of claim 1, wherein the navigation module is to determine a position of the watch relative to the head mounted device based on an inertial motion sensor in the watch,
wherein the AR content mapping module is to generate the display of the AR menu in the transparent display in response to a first position of the watch, and to terminate the display of the AR menu in the transparent display in response to a second position of the watch.

11. A method comprising:
identifying a watch;
mapping and generating, by a hardware processor of a machine, a display of an augmented reality (AR) menu in a transparent display of a head mounted device, the AR menu displayed as a layer on the watch;
detecting a physical user interaction on the watch; and
navigating the AR menu in response to detecting the physical user interaction on the watch.

12. The method of claim 11, further comprising:
receiving an image of the watch from at least one camera of the head mounted device;
determining feature points of the watch; and
identifying the watch based on the feature points.

13. The method of claim 11, further comprising:
establishing a wireless communication with the watch;
receiving an identification of a touch gesture on the watch; and
mapping a navigation function to the identification of the touch gesture on the watch.

14. The method of claim 11, further comprising:
accessing the AR menu corresponding to the watch.

15. The method of claim 11, further comprising:
identifying an object received from at least one camera of the head mounted device; and
retrieving the AR menu corresponding to the identified object.

16. The method of claim 15, further comprising:
determining a geographic location of the head mounted device, to identify the object received from at least one camera of the head mounted device at the geographic location of the head mounted device; and
retrieving the AR menu corresponding to the identified object and based on the geographic location of the head mounted device.

17. The method of claim 11, further comprising:
mapping a size and orientation of the AR menu in the transparent display based on an image of the watch, the AR menu comprising a carousel menu displayed adjacent to the watch; and
updating the display of the AR menu in response to the physical user interaction on the watch, wherein the physical user interaction comprises pressing a button on the watch or touching a touch-sensitive surface of the watch.

18. The method of claim 11, further comprising:
receiving an identification of the physical user interaction on the watch;
retrieving a corresponding navigation command corresponding to the identification of the physical user interaction; and
causing an AR application to perform the corresponding navigation command.

19. The method of claim 11, further comprising:
determining a position of the watch relative to the head mounted device based on an inertial motion sensor in the watch;
generating the display of the AR menu in the transparent display in response to a first position of the watch; and
terminating the display of the AR menu in the transparent display in response to a second position of the watch.

20. A non-transitory machine-readable medium comprising instructions that, when executed by one or more processors of a machine, cause the machine to perform operations comprising:
identifying a watch;
mapping and generating a display of an augmented reality (AR) menu in a transparent display of a head mounted device, the AR menu displayed as a layer on the watch;
detecting a physical user interaction on the watch; and
navigating the AR menu in response to detecting the physical user interaction on the watch.
